(19) United States
(12) Patent Application Publication
(10) Pub. No.: US 2026/0159664 A1
(43) Pub. Date: Jun. 11, 2026

(54) PROCESS FOR THE PRODUCTION OF A HIGH MOLECULAR WEIGHT POLYESTER (CO)POLYMER

(71) Applicant: Avantium Knowledge Centre B.V., Amsterdam (NL)

(72) Inventors: Kevin van der Maas, Amsterdam (NL); Bing Wang, Amsterdam (NL); Robert-Jan Van Putten, Amsterdam (NL); Gerardus Johannes Maria Gruter, Amsterdam (NL)

(21) Appl. No.: 19/125,625

(22) PCT Filed: Oct. 30, 2023
(86) PCT No.: PCT/EP2023/080235

§ 371 Date: Apr. 29, 2025

(30) Foreign Application Priority Data
Nov. 1, 2022 (EP) 22204854.8

(51) Int. Cl. C08J 11/26; C08K 5/12

(52) U.S. Cl. CPC C08J 11/26; C08K 5/12; C08J 2367/03

(57) ABSTRACT

The invention relates to a process for the production of a (high molecular weight) polyester (co)polymer. The process includes (a) adding a diphenyl oxalate ester to a starting polyester (co)polymer at least comprising alcohol end groups and units derived from 1,2-diols, wherein the phenyl group in the diphenyl oxalate ester is optionally substituted; and (b) in case the temperature is not already higher than 220° C., elevating the temperature of the mixture resulting from step (a) to at least 220° C., and reducing the pressure, for a period of time sufficient to obtain a polyester (co)polymer product wherein the amount of oxalate units that remain in the (co)polymer is less than added in the form of the diphenyl oxalate ester; and no or less than 1 mole % oxalate units are present, the percentage relative to a total amount of monomer units.

### FIELD OF THE INVENTION

The invention relates to a process for the production of a high molecular weight polyester (co)polymer and a (catalyst free) (co)polymer obtainable by, or obtained by said process.

### BACKGROUND OF THE INVENTION

One of the most important goals of polymerization processes is to obtain polymers with a molecular weight high enough for the desired application(s). This is important as the molecular weight of the polymer relates to polymer performance e.g., strength, toughness and durability. The use of polymers with insufficient molecular weight may lead to application failures. Therefore, many studies concerning polymerization processes and the conditions used in those processes relate to realizing the target (high) molecular weight.

Polyesterification is a reversible reaction with a relatively low equilibrium constant. As a consequence, removal of the condensation product(s) has an impact on the molecular weight that can be achieved. Melt polycondensation at reduced pressure is commonly used in polyesterification processes for removal of the condensation product(s). However, the increase of molecular weight of the polymers during that process also increases the viscosity of the melt material, which complicates the removal of condensation product(s). This may eventually become a limiting factor. Removal of condensation product(s) can be improved, for example by using higher temperatures, longer reaction times, catalysts and improved reactor designs. However, under melt conditions, limited mass transfer due to high viscosity of the melt material, in combination with longer residence times and (potential) chemical degradation, may limit the possibilities to obtain higher molecular weights. For example, to obtain high molecular weights of polyethylene terephthalate (PET) necessary for bottles (intrinsic viscosity (IV) of 0.73-0.85 dL/g) and industrial yarns (IV>1.2 dL/g), an additional solid-state polymerization (SSP) step may be required. In SSP, polymer pellets are heated below the melting point while being rotated under a nitrogen flow or vacuum. A drawback of SSP is that due to the low mobility of the end groups and condensate in the solid state, this is time and energy consuming, and therefore an expensive process.

When less reactive diols such as isosorbide are introduced (e.g. producing PEIT), it becomes even more difficult to obtain sufficiently high molecular weights. Incorporation of isosorbide is interesting due to its additional benefits on thermomechanical stability and mechanical performance, which opens new possibilities for applications. Isosorbide is less reactive due to its secondary alcohol groups, and melt polycondensation becomes considerably more difficult with increasing isosorbide content. Furthermore, the crystallinity of the polymer is lost with isosorbide contents above around 15%, which makes it impossible to use SSP, as an amorphous polymer would clump together.

An alternative route for producing high molecular weight polymers could be by utilizing a so-called chain extender after melt polycondensation (see e.g. P. Raffa et al., Reactive & Functional Polymers 72 (2012) 50-60). Chain extenders are very reactive molecules which react with the remaining functional chain ends (alcohol and/or acid) to increase the molecular weight. Only little chain extender is needed, as already a considerable chain length is usually obtained after melt polycondensation. Due to the high reactivity of the chain extender considerably less time and less harsh conditions are required to obtain high molecular weight. This can be beneficial to reduce cost by cutting down on polymerization conditions (temperature, time, catalyst, reactor), or to eliminate the need for SSP. Various chain extenders have been used for the production of high molecular weight polyesters, for example ethylene carbonate, bis-oxazolines, pyromellitic dianhydride, organic phosphites, di-isocyanates, di-epoxides, carbonyl biscaprolactam, diphenyl carbonate, diphenyl terephthalate, bisketenimines, and bislactams.

S. Takeo et al., Polymerization Kinetics and Technology 128 (1973) 183-207 discloses a process wherein a small amount of acid derivatives was added to a polycondensation reaction system of poly(ethylene terephthalate) (PET) at a specified stage.

However, the use of chain extenders also comes with drawbacks. The chain extenders are introduced into the polymer and thus become part of the molecular structure of the polyester. The groups that are incorporated into the polymer backbone inevitably influence the properties of the material. Further, often side reactions occur, such as crosslinking or chain scission, which also change the physical properties of the polymer. Moreover, some chain extenders are considerably toxic, on their own, or as residue in polymer, thereby excluding the use thereof for food-grade applications. These drawbacks are probably the reason why today chain extenders are rarely the standard process in commercial polyester production. In addition, as a consequence of the use of the currently known chain extenders, when the produced polymer is to be recycled, the chemical structure of the resulting polymer is further altered after each recycling session. This complicates the end life of the polymer and limits the amount of possible recycling sessions.

Furthermore, there is a desire for processes for the production of high molecular weight polyesters which do not require the presence of a metal catalyst. For example, the majority of PET currently is produced using antimony (Sb) catalysts, however, there are concerns about depletion of Sb reserves. Furthermore, in medical applications metal catalysts are often undesired because of toxicity.

Therefore, there is a need for alternative, improved processes for the production of high molecular weight polyesters, which do not require high energy consumption and/or which do not have one or more of the drawbacks of the use of the commonly known chain extenders.

### SUMMARY OF THE INVENTION

According to the present invention, such an improved process is provided. The present invention relates to a process for the production of a (high molecular weight) polyester (co)polymer, comprising (a) adding a diphenyl oxalate ester to a starting polyester (co)polymer at least comprising alcohol end groups and units derived from 1,2-diols, wherein the phenyl group in the diphenyl oxalate ester is optionally substituted, the substituent being selected from one or more of o-, m- and p-C1-C6 alkoxy, and o-, m- and p-C1-C6 alkyl; (b) in case the temperature is not already higher than 220° C., elevating the temperature of the mixture resulting from step (a) to at least 220° C., and reducing the pressure, for a period of time sufficient to obtain a polyester (co)polymer product wherein the amount of oxalate units that remain in the (co)polymer is less than added in the form of the diphenyl oxalate ester; and no or less than 1 mole % oxalate units are present, the percentage relative to the total amount of monomer units, the product having a higher molecular weight than that of the starting polyester (co)polymer, wherein the process is carried out in the absence of a metal catalyst.

In the process of the invention, a diphenyl oxalate ester is used as “molecular weight booster” under relatively mild conditions instead of a so-called “chain extender” according to the prior art processes. As discussed above, commonly used chain extenders cope with drawbacks, as they are incorporated into the polymer chain and alter the physical properties of the polymer and may leave toxic residues. Advantageously, the diphenyl oxalate ester used according to the process of the invention is an actual molecular weight booster that is not incorporated into the polymer chain of the final product, and as a consequence, does not influence the polymer properties (apart from the molecular weight and properties related to the molecular weight only), nor does it leave any toxic residue in the polymer end product.

Furthermore, by using the molecular weight booster according to the invention the use of a (metal) catalyst in the process may be avoided altogether, as polyester chains of low molecular weight can be formed via autocatalysis (in the absence of metal catalyst) and subsequently connected by using the highly reactive diphenyl oxalate, which is subsequently removed from the polymer chain upon heating.

The high reactivity of the diphenyl oxalate ester, in particular of bis(2-methoxyphenyl) oxalate, provides flexibility in its use in polymerization processes. It can be used as alternative to SSP in the case of crystalline polymers, or it may open up routes to produce polymers of less reactive or labile monomers as less severe reaction conditions are required to reach sufficient molecular weights. For example, for polymers containing isosorbide-derived units it is important to obtain high molecular weight directly after melt polycondensation as they are amorphous (in case the isosorbide content is over about 10-15 mole %) and SSP is not possible. The process of the present invention may further allow for more effective recycling of certain polymers, as the process allows to increase the number of recycle sessions without altering the physical properties of the polymers that are produced in each of the recycle sessions.

The present invention provides an advantageous process for the preparation of both existing and, in particular, novel polyester (co)polymers while obtaining high number average molecular weights of the polyester end product. For example, advantageously, according to the presently claimed process, it may be possible to produce very high molecular weight polyethylene furanoate (PEF) up to 200 kg/mol (Mw) without the addition of a metal catalyst. The absence of a metal catalyst can be advantageous from multiple perspectives. For example, the majority of PET currently is produced using antimony (Sb) catalysts, however, there are concerns about depletion of Sb reserves. Furthermore, in medical applications metal catalysts are often undesired because of toxicity.

Thus, as a further aspect, the invention relates to certain novel high molecular weight (co)polymers, and in particular to novel high molecular weight (co)polymers that were produced without addition of a catalyst.

The novel high molecular weight polyester (co)polymers produced according to the invention can advantageously be used in a broad range of (industrial) applications, such as in fibres, injection (blow) moulded parts and bottles, 3D printing, packaging materials, etc.

In addition, the invention provides a composition comprising any one of said novel polyester (co)polymers and in addition one or more additives and/or one or more additional polymers.

Further, the invention provides an article comprising the polyester (co)polymer according to the present invention or a composition comprising said polyester (co)polymer and one or more additives and/or additional (co)polymers.

### DETAILED DESCRIPTION OF THE INVENTION

The present invention relates to a process for the production of a polyester (co)polymer, in particular for the production of a high molecular weight polyester (co)polymer.

By a “polyester” herein is understood a polymer comprising a plurality of monomer units linked via ester functional groups in its main chain. An ester functional group can be formed by reacting a hydroxyl group (—OH) with a carboxyl/carboxylic acid group (—C(═O)OH). Typically, a polyester is a synthetic polymer formed by the reaction of one or more bifunctional carboxylic acids with one or more bifunctional hydroxyl compounds. Polyesters may also comprise units derived from monomers carrying both a hydroxyl group and a carboxylic acid group, such as hydroxycarboxylic acids, like lactic acid (LA) and glycolic acid (GA), and hydroxyalkanoates (HA), and the like. By a “polyester copolymer” is herein understood a polyester wherein three or more types of monomer units are joined in the same polymer main chain. By the term “starting polyester (co)polymer” herein is understood the initial polyester (co)polymer that is used as a starting point to increase its molecular weight.

By a “monomer unit” is herein understood a unit as included in a polyester (co)polymer or oligomer, which unit can be obtained after polymerization of a monomer, that is, a “monomer unit” is a constitutional unit contributed by a single monomer or monomer compound to the structure of the polymer or oligomer, herein in particular the smallest diol or di-acid repeating unit.

By a “monomer” or “monomer compound” is herein understood the smallest building block used as the starting compound to be polymerized, such as a diol or di-acid compound, but also a hydroxycarboxylic acid.

By an “oligomer” or “oligomer compound” is herein understood a molecular structure comprising an in total average number of monomer units of in the range from equal to or more than 2 to equal to or less than 50 monomer units, and preferably at least 25 monomer units. Next to diol and di-acid derived monomer units, also other monomer units may be part of the oligomer, such as hydroxycarboxylic acid derived monomer units, in particular derived from α-hydroxycarboxylic acids, such as glycolic acid, lactic acid, mandelic acid, 3-alkoxy carbonic acid, and the like.

The present invention relates to a process for the production of a high molecular weight polyester (co)polymer, comprising the use of a diphenyl oxalate ester as molecular weight booster. The term “molecular weight booster” herein relates to a chemical that is used to increase the molecular weight of a polymer by assisting chain extension of the polymer, thereby forming a polymer product with higher molecular weight without becoming part of the polymer product itself, i.e. the chemical is not incorporated as a unit into the polymer chain.

In the prior art, diphenyl oxalate esters have been described as a constitutive component in the production of polyesters, forming a polyester product comprising oxalate units, see e.g. WO2018211132, WO2018211133 and WO2020106144. However, the use of (small amounts of) diphenyl oxalate esters as molecular weight booster in a polymerization process, wherein the oxalate species may merely be transiently present in an intermediate polymeric species essentially without ending up in the final product, has never been described or suggested.

The present process relates to the production of a polyester (co)polymer, comprising adding a diphenyl oxalate ester as molecular weight booster to a starting polyester (co)polymer at least comprising alcohol end groups and units derived from 1,2-diols. Particularly advantageous are starting polyester (co)polymers comprising glycol derived end groups. The term “glycol derived end groups” herein means: end groups wherein two hydroxyl (—OH) groups are attached to different carbon atoms, such as is the case when the end group is derived from for example mono ethylene glycol, 1,2-propanediol, 2,3-butanediol, and the like A preferred glycol derived end group is the group derived from mono ethylene glycol, i.e. the 2-hydroxyethyl end group.

Advantageously, in the current process only a small amount of the diphenyl oxalate ester is needed to have the molecular weight boosting effect. Amounts as small as 0.2 mol % of the diphenyl oxalate ester may be suitable, more preferably 0.4 mol %; in particular, an amount of up to 10 mol % is used, preferably up to 5 mol %, more preferably up to 2 mol %, the percentages being relative to the total amount of monomers in the starting polyester (co)polymer. Ideally, the amount of diphenyl oxalate ester used is about half the amount of the total amount of diols present in the starting polyester (co)polymer. The addition of the diphenyl oxalate ester may be done either in portions or all at once, depending on the circumstances and the desired product. With a stoichiometric ratio of the diphenyl oxalate ester to the reactive end groups it is likely that very high molecular weight can be obtained within a very short time. Thus, ideally, and if appropriate, the amount of moles of the diphenyl oxalate ester used in the process is about equal to the amount of moles of glycol derived end groups present in the starting polyester (co)polymer.

The molecular weight booster of the present invention is based on phenyl esters of oxalate, wherein the phenyl group may optionally be substituted, the substituent being selected from one or more of o-, m- and p-C1-C6 alkoxy, and o-, m- and p-C1-C6 alkyl. Herein, o-, m- and p- respectively mean ortho-substituted, meta-substituted, and para-substituted. Preferably, the phenyl group (in the oxalate ester) is mono-substituted, particularly with a mono-C1-C6 alkoxy substituent. In a particularly preferred embodiment, the phenyl group (in the oxalate ester) is mono-substituted on the ortho (o-) position with a C1-C6 alkoxy substituent. Particularly preferred are diphenyl oxalate and bis(2-methoxyphenyl) oxalate (or diguaiacyl oxalate, DGO). The diphenyl oxalate ester possesses a very high reactivity towards alcohol groups, even to such an extent that in the process an additional catalyst may not be needed. The reactivity comes from the good leaving group ability of the phenyl groups, in combination with the structure of oxalate where the carboxyl groups are directly connected to each other. It was found that DGO is considerably more reactive than diphenyl oxalate, and therefore DGO is particularly preferred as molecular weight booster in the process of the present invention. The high reactivity is likely related to the steric hinderance of the methoxy group attached to the phenyl ring. From environmental perspective, DGO is a safe choice, safer than for example diphenyl oxalate, as the leaving group guaiacol is a non-toxic one (as opposed to phenol).

It is hypothesized that in the course of the process of the invention an oxalate ring product is formed from an intermediate oxalate species and the glycol derived end groups or other suitable diol derived units (that were originally present in the starting polyester (co)polymer). It is believed that chain ends couple leading to an increase of the molecular weight and the oxalate ring product is removed at elevated temperature and vacuum, while further removing the related phenol that is also released during the process. Furthermore, in the course of the reaction, it is possible that also other suitable diol derived units within an intermediate polymer product react with an intermediate oxalate species (i.e. reactions between chains can take place) to form an oxalate ring product that is removed at elevated temperature and vacuum, while having a molecular weight boosting effect. While the oxalate ring product and phenol are removed from the process, high molecular weight polymers are formed (essentially) without oxalate derived units in the polymer chain. Only minor, hardly detectable or indetectable, amounts of oxalate derived units may remain in the polymer chain of the product.

For instance, when using DGO as molecular weight booster, an intermediate oxalate species is formed, that is (without being bound to theory) possibly a part of the polymer chain, which species forms a six membered ring with the 1,2-diol derived units. Thus, for example, in the case of adding DGO to a polymer with ethylene glycol derived end groups, an ethylene oxalate ring is formed (1,4-dioxane-2,3-dione). The produced ethylene oxalate and guaiacol can be removed from the polymer at elevated temperature and reduced pressure, while leaving behind a high molecular weight polymer without any residue of the molecular weight booster in the chain.

Advantageously, no or essentially no residue (less than 1 mol %) of units of the molecular weight booster remains in the polymer chain. Therefore, this process does not alter the physical and chemical properties of the polymer produced at the end of the process. This is a significant advantage, especially when a polymer product is subjected to repeated recycling. Consequently, the polymer product properties are not changed by the current process, even after recycling. It is further advantageous for recycling processes to have no catalyst present in the polymer to avoid build-up of metals. Favorably, according to the process of the invention the use of a catalyst may be avoided.

A further advantage of the current process is that the cyclic oxalate species and the phenolic alcohol may suitably be recycled. Advantageously, building blocks like oxalate, ethylene glycol and guaiacol may be re-introduced into the process for re-use.

The current process relates to the production of a high molecular weight polyester (co)polymer, particularly wherein at least one of the units derived from a 1,2-diol is derived from an aliphatic diol selected from mono ethylene glycol, 1,2 propanediol, 1,2-butanediol, 2,3-butanediol and 1,2-cyclohexanediol.

Additional diols that may be used in the current process, other than the linear diols as defined herein above, may be any suitable diol, primary and secondary, and may preferably be selected from cis- and/or trans-2,2,4,4-tetramethyl-1,3-cyclobutanediol, and 1,4:3,6-dianhydrohexitols, in particular isosorbide. Thus, the starting polyester (co)polymer may comprise additional diol derived units, preferably selected from cis- and/or trans-2,2,4,4-tetramethyl-1,3-cyclobutanediol, and 1,4:3,6-dianhydrohexitols, in particular isosorbide.

Suitably, the starting polyester may be any (co)polymer comprising alcohol end groups and units derived from 1,2-diols. Preferably, the starting polyester (co)polymer comprises dicarboxylic acid derived units, the dicarboxylic acids or any esters thereof selected from (hetero)aromatic dicarboxylic acids or any esters thereof (preferably be selected from terephthalic acid, a terephthalic acid monoester, a terephthalic acid diester, a furandicarboxylic acid, a furandicarboxylic acid monoester, and a furandicarboxylic acid diester) and C2-C18 aliphatic dicarboxylic acids or any esters thereof, which may be linear, cyclic or branched dicarboxylic acids, such as, but not limited to, 1,4-cyclohexanedicarboxylic acid, diglycolic acid, and especially linear dicarboxylic acids of the formula HOOC(CH₂)ₙCOOH wherein n is an integer of 0 to 20.

In a preferred embodiment, the starting polyester (co)polymer contains dicarboxylic acid units derived from terephthalic acid and/or a furandicarboxylic acid (in particular 2,5-furandicarboxylic acid) and mono ethylene glycol derived units, and optionally isosorbide derived units (depending on the desired properties of the final polyester (co)polymer product).

The process of the invention is preferably performed as follows, comprising
(i) providing or producing the starting polyester (co)polymer, wherein the process for producing the polyester (co)polymer comprises esterification/transesterification and polycondensation;
(ii) adding the diphenyl oxalate ester to the starting polyester (co)polymer;
(iii) elevating the temperature of the mixture resulting from step (ii) to at least 220° C., or, in case the temperature is already higher than 220° C., maintaining the temperature for a period of time;
(iv) reducing pressure, preferably to at most 5 mbar, more preferably to equal to or below 1 mbar, thereby removing the phenol (coming from the diphenyl oxalate ester) and producing a (co)polymer product; and
(v) optionally repeating steps (ii) to (iv) one or more times with as starting material the (co)polymer with the higher molecular weight of the previous step (iv) until a final polyester (co)polymer product is produced wherein no or less than 1 mole % oxalate units are present, the percentage relative to the total amount of monomer units, and with the desired high molecular weight properties.

A preferred step (i) comprises producing the starting polyester (co)polymer by reacting a dicarboxylic acid or ester thereof with a diol and/or polyol and/or oligomer with diol derived end groups [such as bis(2-hydroxyethyl) terephthalate {BHET}, and other terephthalate oligomers, e.g. PET glycolysis products, see e.g. T. Spychaj in “Handbook of thermoplastic polymers”, 2002 Wiley, Chapter 27, p 1259-61], optionally in the presence of a catalyst, wherein at least one of the diols and/or polyols and/or oligomer with diol derived end groups comprises a vicinal diol group. Preferably, the diol and/or polyol and/or oligomer with diol derived end groups is selected from a linear diol selected from saturated C2-C12 aliphatic diol compounds, and BHET, and preferably from mono ethylene glycol, 2,3-butanediol, 1,2-cyclohexanediol, and at least comprises adjacent hydroxy groups (i.e. vicinal diols).

As indicated, the polymer in step (a) of the process may be readily prepared for this purpose in step (i), as described herein above, but may also advantageously be a recycled polymeric material or derived therefrom. Preferably, such polyester (co)polymer from recycling sources contains an aliphatic 1,2-diol derived unit, the diol selected from mono ethylene glycol, 1,2-propanediol, 1,2-butanediol, 2,3-butanediol and 1,2-cyclohexanediol.

The temperature in step (iii) depends on the type of the polyester (co)polymer that is produced. Suitably, the temperature is high enough when after addition of the diphenyl oxalate ester the material melts or is still in a molten state and the mixture can properly be stirred. For more flexible polyester (co)polymers with low melting points, the temperature may for example be at least 220° C., for more rigid polyester (co)polymers, such as PET or PEF polymers, the temperature preferably needs to be at least 230° C.

As a further interesting aspect of the currently claimed process, the process has been scaled up to a kilogram scale synthesis of isosorbide containing PET and PEF (co)polyesters (PEIT and PEIF) with high molecular weights, which demonstrates the potential of the use of the molecular weight booster. In the scaled up process, the molecular weight booster may advantageously be added at the end of the polycondensation (see step (ii) above) or in an extruder, together with the (co)polymer that is to be extruded.

The molecular weight boosting strategy of the present invention was shown to be relatively easy to scale up. As an example, the diphenyl oxalate ester DGO can be effectively synthesized from the transesterification of dimethyl oxalate and guaiacol. Advantageously, only a relatively small amount of DGO is required to have the desired molecular weight boosting effect. For example, for larger scale production of PEF only around 20 to 100 g of DGO per kg of PEF may be needed. This makes this strategy economically attractive, but also easy to apply to existing reactor setups. The diphenyl oxalate ester can for example be fed to the reaction vessel via a catalyst addition funnel. Further, by increasing the polycondensation time or adding a catalyst, the required amount of the diphenyl oxalate ester can be reduced.

In a ton scale polymer production, the result may still be the production of kilograms of guaiacol (in case DGO is used) and ethylene oxalate ring as condensates. To make the process more economic and sustainable, and commercially attractive, the condensates should have a designated use. Guaiacol could be recycled and reused in the DGO synthesis process. Ethylene oxalate may also be reused for DGO synthesis as well, however it is probably more efficient to use it directly as a monomer. Ethylene oxalate may for example be used to produce polyethylene oxalate by ring opening polymerization, or it may be combined with other ring opening monomers, such as lactide and glycolide to produce PLA and PGA polymers comprising oxalate units.

In a further aspect, the invention relates to new (co)polyesters obtainable by, or obtained by, the currently claimed process. The process allows the preparation of a range of existing and novel polyester (co)polymers with high molecular weights that conventionally would not be obtainable. In an embodiment of the invention, the process comprises a step (i) wherein the starting polyester (co)polymer was produced using a catalyst, followed by steps (ii) to (v). Such a process combines the favourable features of the present invention and features of existing polyester production methods. In another preferred embodiment no catalyst is used in the entire process, allowing the production of metal catalyst free polyester (co)polymers, that may be advantageous for certain uses requiring the absence of any catalyst, such as medical uses of polyesters. Thus, in an embodiment, preferably the (novel) polyester that is produced is a metal catalyst free (i.e. less than 1 ppm of metals present) polyester (co)polymer, i.e. which was produced without addition of a metal catalyst, and preferably with Mn of 20 kDa or more, the polyester being selected from:
poly(ethylene furan-2,5-dicarboxylate);
poly(ethylene co-isosorbide furan-2,5-dicarboxylate);
poly(ethylene co-isosorbide co-cyclohexanedimethylene furan-2,5-dicarboxylate);
poly(ethylene co-isosorbide terephthalate) with isosorbide content of 15% or higher;
poly(ethylene co-isosorbide co-cyclohexanedimethylene terephthalate);
poly(ethylene furan-2,5-dicarboxylate co-terephthalate);
poly(ethylene co-isosorbide furan-2,5-dicarboxylate co-terephthalate);
   wherein the Mn is measured using gel permeation chromatography with poly(methyl methacrylate) standards as reference material.

The weight average molecular weight (Mw) and the number average molecular weight (Mn) can be determined by means of gel permeation chromatography (GPC) at 35° C., using for the calculation poly(methyl methacrylate) standards as reference material, and using hexafluoro-2-propanol as eluent.

The polyester (co)polymer obtainable by or obtained by the process of the invention can suitably be combined with additives and/or other (co)polymers and therefore the invention further provides a composition comprising said polyester copolymer and in addition one or more additives and/or one or more additional other (co)polymers.

Such composition can for example comprise, as additive, nucleating agents. These nucleating agents can be organic or inorganic in nature. Examples of nucleating agents are talc, calcium silicate, sodium benzoate, calcium titanate, boron nitride, zinc salts, porphyrins, chlorin and phlorin.

The composition according to the invention can also comprise, as additive, nanometric (i.e. having particles of a nanometric size) or non-nanometric and functionalized or non-functionalized fillers or fibres of organic or inorganic nature. They can be silicas, zeolites, glass fibres or beads, clays, mica, titanates, silicates, graphite, calcium carbonate, carbon nanotubes, wood fibres, carbon fibres, polymer fibres, proteins, cellulose fibres, lignocellulose fibres and nondestructured granular starch. These fillers or fibres can make it possible to improve the hardness, the stiffness or the permeability to water or to gases. The composition can comprise from 0.1% to 75% by weight, for example from 0.5% to 50% by weight, of fillers and/or fibres, with respect to the total weight of the composition. The composition can also be of composite type, that is to say can comprise large amounts of these fillers and/or fibres.

The composition can also comprise, as additive, opacifying agents, dyes and pigments. They can be chosen from cobalt acetate and the following compounds: HS-325 Sandoplast® Red BB, which is a compound carrying an azo functional group also known under the name Solvent Red 195, HS-510 Sandoplast® Blue 2B, which is an anthraquinone, Polysynthren® Blue R and Clariant® RSB Violet.

The composition can also comprise, as additive, a processing aid for reducing the pressure in the processing device. A mould-release agent, which makes it possible to reduce the adhesion to the equipment for shaping the polyester, such as the moulds or the rollers of calendering devices, can also be used. These agents can be selected from fatty acid esters and amides, metal salts, soaps, paraffins or hydrocarbon waxes. Specific examples of these agents are zinc stearate, calcium stearate, aluminium stearate, stearamide, erucamide, behenamide, beeswax or Candelilla wax.

The composition can also comprise other additives, such as stabilizers, etc. as mentioned herein above.

In addition, the composition can comprise one or more additional polymers other than the one or more polyester (co)polymers according to the invention. Such additional polymer(s) can suitably be chosen from the group consisting of polyamides, polystyrene, styrene copolymers, styrene/acrylonitrile copolymers, styrene/acrylonitrile/butadiene copolymers, polymethyl methacrylates, acrylic copolymers, poly(ether/imide)s, polyphenylene oxides, such as poly(2,6-dimethylphenylene oxide), polyphenylene sulfide, poly(ester/carbonate)s, polycarbonates, polysulphones, polysulphone ethers, polyetherketones and blends of these polymers.

The composition can also comprise, as additional polymer, a polymer which makes it possible to improve the impact properties of the polymer, in particular functional polyolefins, such as functionalized polymers and copolymers of ethylene or propylene, core/shell copolymers or block copolymers.

The compositions according to the invention can also comprise, as additional polymer(s), polymers of natural origin, such as starch, cellulose, chitosans, alginates, proteins, such as gluten, pea proteins, casein, collagen, gelatin or lignin, it being possible or not for these polymers of natural origin to be physically or chemically modified. The starch can be used in the destructured or plasticized form. In the latter case, the plasticizer can be water or a polyol, in particular glycerol, polyglycerol, isosorbide, sorbitans, sorbitol, mannitol or also urea. Use may in particular be made, in order to prepare the composition, of the process described in the document WO 2010/010282A1.

These compositions can suitably be manufactured by conventional methods for the conversion of thermoplastics. These conventional methods may comprise at least one stage of melt or softened blending of the polymers and one stage of recovery of the composition. Such blending can for example be carried out in internal blade or rotor mixers, an external mixer, or single-screw or co-rotating or counter-rotating twin-screw extruders. However, it is preferred to carry out this blending by extrusion, in particular by using a co-rotating extruder. The blending of the constituents of the composition can suitably be carried out at a temperature ranging from 220 to 300° C., preferably under an inert atmosphere. In the case of an extruder, the various constituents of the composition can suitably be introduced using introduction hoppers located along the extruder.

The invention also relates to an article comprising a polyester (co)polymer according to the invention or a composition comprising a polyester (co)polymer according to the invention and one or more additives and/or additional polymers. The polyester (co)polymer may conveniently be used in the manufacturing of films, fibres, injection moulded parts and packaging materials, such as for example receptacles. The use of the polyester (co)polymer is especially advantageous where such films, fibres, injection moulded parts or packaging materials need to be heat-resistant or cold-resistant.

The article can also be a fibre for use in for example the textile industry. These fibres can be woven, in order to form fabrics, or also nonwoven.

The article can also be a film or a sheet. These films or sheets can be manufactured by calendering, cast film extrusion or film blowing extrusion techniques. These films can be used for the manufacture of labels or insulators.

This article can be a receptacle especially for use for hot filling and reuse applications. This article can be manufactured from the polyester (co)polymer or a composition comprising a polyester (co)polymer and one or more additives and/or additional polymers using conventional conversion techniques. The article can also be a receptacle for transporting gases, liquids and/or solids. The receptacles concerned may be baby's bottles, flasks, bottles, for example sparkling or still water bottles, juice bottles, soda bottles, carboys, alcoholic drink bottles, medicine bottles or bottles for cosmetic products, dishes, for example for ready-made meals or microwave dishes, or also lids. These receptacles can be of any size.

The article may for example be suitably manufactured by extrusion-blow moulding, thermoforming or injection-blow moulding.

The present invention therefore also conveniently provides a method for manufacturing an article, comprising the use of one or more polyester (co)polymers according to the invention and preferably comprising the following steps: 1) the provision of a polyester (co)polymer obtainable by or obtained by the process of this invention; 2) melting said polyester (co)polymer, and optionally one or more additives and/or one or more additional polymers, to thereby produce a polymer melt; and 3) extrusion-blow moulding, thermoforming and/or injection-blow moulding the polymer melt into the article.

The article can also be manufactured according to a process comprising a stage of application of a layer of polyester in the molten state to a layer based on organic polymer, on metal or on adhesive composition in the solid state. This stage can be carried out by pressing, overmoulding, lamination, extrusion-lamination, coating or extrusion-coating.

Advantageously, high molecular weight polyester (co)polymers produced according to the process of the invention can be used in 3D printing. In case very high molecular weights are desired, the use of alternative types of reactors could potentially be a solution, such as extruders and compounders that are known to be used with polymers produced with several types of chain extenders. For example, a spinning disk reactor is highly suitable for processing highly viscous polymers.

### BRIEF DESCRIPTION OF THE DRAWINGS

FIG. 1. Stepwise addition of DGO to a post-polycondensation sample of PEF. (Example 2A) After each addition (1, 2, 3.5 mol %) ¹H NMR of the resulting polymer was taken.

FIG. 2. Autoclave experiment with stepwise DGO addition (PEIT) (Example 3). Autoclave parameters of the experiment: torque, temperature and stir speed. The experiment starts after a short polycondensation of PEIT without catalyst. The molecular weight booster (DGO) is added portion wise (5×). Each addition of DGO is marked. The torque spikes are momentarily caused by the addition of DGO.

FIG. 3. ¹H-NMR of PEIT in TCE-d2, produced by the autoclave experiment of Example 3.

FIG. 4. ¹H-NMR of PEIF in TCE-d2, produced in Example 4.

FIG. 5. 3D printed designs with high Mn PEIT of Example 3. Small storage box with lid, benchy and flex clip.

The invention is further illustrated by the following non-limiting examples.

### EXAMPLES

### List of Abbreviations

BHET=Bis(2-hydroxyethyl) terephthalate
DCM=dichloromethane
DEG=diethylene glycol
DGO=diguaiacyl oxalate
EG=ethylene glycol
FDCA=2,5-furandicarboxylic acid
ISO=isosorbide
MEG=mono ethylene glycol
PDI=polydispersity index
PEF=polyethylene furan-2,5-dicarboxylate
PEFT=polyethylene furanoate co-terephthalate
PEICF=polyethylene co-isosorbide co-cyclohexanedimethanol furan-2,5-dicarboxylate
PEICT=polyethylene co-isosorbide co-cyclohexanedimethanol terephthalate
PEIF=polyethylene co-isosorbide furan-2,5-dicarboxylate
PEIFT=polyethylene co-isosorbide furan-2,5-dicarboxylate co-terephthalate
PEIT=polyethylene co-isosorbide terephthalate
PET=polyethylene terephthalate
RPM=rotations per minute
SSP=solid state polymerization
TEAOH=tetraethylammonium hydroxide
THF=tetrahydrofuran
TPA=terephthalic acid

### Materials and Reagents

Ethylene glycol (>99%), triethylamine (99%), titanium(IV)isopropoxide (97%), diphenyl terephthalate (98%), diphenyl carbonate (99%) were supplied by Sigma Aldrich. Guaiacol (99%) was purchased from Carbosynth. Isosorbide (>99.5%) was supplied by Roquette. Dimethyl oxalate (>99%) and BHET (>85%) were bought from TCI chemicals. Diguaiacyl oxalate was synthesized in-house (see Example 1). Tetrahydrofuran (99%), dichloromethane (99%), diethyl ether (99%), sodium bicarbonate (99.5%), sodium sulfate (99%; anhydrous), sodium chloride (>99%) were supplied by VWR International. TCE-d2 (99.5%) and DMSO-d6 (99.8%) were ordered from ABCR chemicals. Titanium tetraphenoxide was produced as described in WO2003080705.

### Characterization

### NMR

¹H-NMR and ¹³C-NMR spectra were recorded at appropriate frequencies on a Bruker AV 300 (1H, 300.10 MHz), a Bruker DRX300 (1H, 300.13 MHz), a Bruker AMX 400 (1H, 400.13 MHz), a Bruker DRX 500 (1H, 499.91 MHz) spectrometers and a Bruker Avance III HD 600. Chemicals shift are referenced to residual proton in the specified solvent.

### DSC

Differential scanning calorimetry thermograms were obtained with a Mettler Toledo DSC 3 STAR^{e} system. Around 5 mg of sample was weighed in a standard aluminum crucible (40 μl). Next the sample was analyzed in three steps, under a nitrogen flow of 50 ml*min⁻¹. First, after stabilizing at 20° C. for 5 minutes, the sample was analyzed at a rate of 10° C.*min⁻¹ from 20-250° C. Second, the sample was cooled down to the starting temperature of 20° C. with a cooling rate of 50° C.*min⁻¹. Lastly, the first step is repeated, and the data of this cycle is used for reporting.

### GPC

GPC measurements were performed at 35° C. For the calculation PMMA standards were used as reference material. As eluent HFIP was used at 1 mL/min. The GPC measurements were carried out under these conditions on a Hitachi Chromaster 5450 with a Agilent HPLC system equipped with two PFG 7 micrometer (μm) Linear M (300×7.5 mm) columns. Calculation of the molecular weights was carried out with Astra 6 Software.

### For PEIF:

Molecular mass distributions were measured using size exclusion chromatography (SEC) on a Shimadzu LC-20AD system with two PLgel 5 μm MIXED-C columns (Polymer Laboratories) in series and a Shimadzu RID-10A refractive index detector, using polystyrene standard and dichloromethane as mobile phase at 1 mL/min and T=35° C.

### Filament Making

### PEIT:

The filament was made on a Precision 350 filament maker from the company 3Devo. The following settings were used: Heater 1 (240° C.), 2 (225° C.), 3 (220° C.), 4 210° C.), screw speed (5 RPM), fan speed 5% and filament diameter 2.85 mm.

### PEIF:

The filament was made on a Precision 350 filament maker from the company 3Devo. The following settings were used: Heater 1 (240° C.), 2 (230° C.), 3 (230° C.), 4 (215° C.), screw speed (5 RPM), fan speed 5% and filament diameter 2.85 mm.

### 3D Print

3D models were printed on a Ultimaker 3 Extended. The heat plate was prepared by coating with a glue stick. The following settings were used for PEIT: Heat plate (85° C.), Nozzle (230° C.), infill (20-100%), print speed (60 mm/s), fan speed (20%) and layer height (0.2 mm).

### Example 1

Diguaiacyl Oxalate from Dimethyloxalate and Guaiacol

1192 g guaiacol (9.6 mol; 2.94 eq), 386 g dimethyloxalate (3.27 mol; 1 eq) and 2.9 g titanium tetraphenoxide (5 mmol; 1.7 meq) were transferred to a steel 2 L kiloclave (Buchi). The reactor pressure was set to 3 bar with a N₂ bleed of 2 L/h. The heater oil temperature was set to 275° C. (245° C. internal); when the reactor temperature reached 100° C. stirring speed was set to 100 RPM. The reaction was followed by removing and monitoring the products in the condensation flask. After 4 hours of reaction time the pressure was slowly lowered to 2 bars, and the reaction was continued for 2 hours. Next, the oil temperature was set to 250° C. (225° C. internal) and the pressure was slowly lowered to atmospheric pressure until the guaiacol slowly distilled over. When distillation decreased to a minimum, pressure was lowered further by using a vacuum pump. At a pressure of 10 mbar, the condensation flask was drained. Next, full vacuum was applied (<0.1 mbar) at an oil temperature of 260° C. to distill over the product. The condensation product (300 g) was dissolved in THF (500 mL), and left to crystallize overnight. The obtained crystals were filtered off and washed with 2×200 mL diethyl ether. The crystals were dried at 60° C. under reduced pressure (1 mbar). The obtained product (225 g) was analyzed by ¹H-NMR and DSC for its purity, which is typically above 99%.

### Example 2—Small Scale Polycondensation of PEF with DGO Molecular Weight Boosting (5 Mole % Directly), in the Absence of a Metal Catalyst

A 100 mL three neck round bottom flask was charged with 20.6 g FDCA (132 mmol, 1 eq), 10.3 g ethylene glycol (166 mmol, 1.25 eq) and 15 mg of ether suppressant (TEAOH 35% water solution). The round bottom flask was put in an oil bath and equipped with a mechanical stirrer, nitrogen inlet and short path connected Schlenk flask, all suited for high vacuum. The polymerization was carried out in three steps: transesterification, polycondensation and molecular weight boosting step.

In the transesterification step, nitrogen flow was set to 50 mL/min, stirring speed to 100 RPM and the temperature of the oil bath was set to 220° C. The set temperature was reached in about 30 minutes. The first transesterification step was considered complete after a clear melt was obtained after 2 hours. The transesterification was continued for an additional 30 minutes before polycondensation was started.

In the polycondensation step, the temperature was set to 260° C. and vacuum was applied (200 mbar). Vacuum was slowly decreased to <1 mbar in 30 minutes. Full vacuum was maintained for 1 hour before starting with the molecular weight boosting.

In the molecular weight boosting step, under a nitrogen flow 2.0 g (6.6 mmol; 5 mole % with respect to FDCA) of DGO was added to the melt. The melt was stirred for 5 minutes after which vacuum was slowly applied. In 15 minutes full vacuum (1 mbar) was reached and maintained for 10 minutes.

In this experiment, DGO (5 mol % with respect to FDCA) was added directly after melt polycondensation. Only a very short period of vacuum was applied (30 min) after the addition of DGO to remove most of the condensates with the intention of thereafter increasing the molecular weight by SSP. Surprisingly, already very high molecular weight was obtained in just 30 min after addition of DGO: Mn=42.2 kDa: Mw=127.3 kDa.

Note 1: This is close to what is obtained for a typical PEF polymerization (see “Comparative Example” below for process description) with catalyst after 24 hours SSP at 200° C.: 59.2/137.7 kDa (Mn/Mw).

Note 2: Results for typical PEF polymerization after polycondensation when using a polycondensation catalyst (i.e. before SSP): Mn=28.6 kDa; Mw=63.0 kDa. And after polycondensation without the use of a polycondensation catalyst (i.e. before SSP): 13.0/25.0 kDa (Mn/Mw).

### Comparative Example

### General Protocol Typical Conventional PEF Synthesis:

A mixture of 2,5-furandicarboxylic acid (30 g, 1.92E-2 mol), catalyst Sb₂O₃ (10.5 mg, 3.60E-5 mol), suppressant tetraethylammonium hydroxide (21 mg 35w % aq sol., 4.99E-5 mol) and MEG (14.30 g, 2.30E-2 mol) was stirred under N₂ atmosphere and heated to an oil temperature of 200° C., and after 20 minutes the oil temperature was raised to 220° C. After keeping the oil temperature at 220° C. for 180 minutes, vacuum was applied to lower the pressure from 1000 mbar to 1 mbar in ca 20 minutes. As soon as the pressure reached 100 mbar, the oil temperature was raised to 260° C. Polycondensation (at pressure≤1 mbar and Tₒᵢₗ=260° C.) was conducted for 75 minutes, after which vacuum was released with N₂ and the melt resin was taken out of the reactor.

### General Protocol Solid State Polymerization:

The resin obtained after melt polymerization was grinded and sieved, after which the sieve fraction of 0.6-2.0 mm was dried/crystallized overnight in an oven at a temperature of 150° C. The material obtained was subjected to solid state polymerization for 24 h under nitrogen atmosphere at an oil temperature of 200° C. After cooling to room temperature, the resin obtained was sieved, after which the sieve fraction of 1.4-2.0 mm was subjected to further analyses.

### Example 2A—Effectiveness of DGO as Molecular Weight Booster (PEF)—in the Absence of a Metal Catalyst

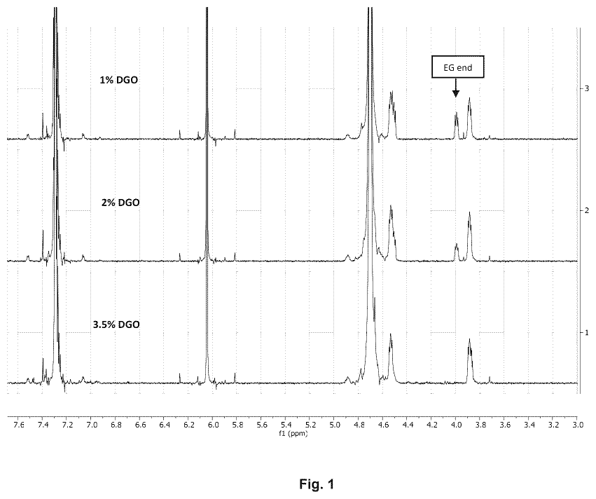

To further investigate the effectiveness of using DGO as a molecular weight booster (i.e. leaving no residue in the product), DGO was added portion wise to a polymer (PEF) of relatively low molecular weight. After each addition full vacuum was applied for 30 minutes. Then, a sample was taken from the melt, before the next addition. Each of the samples was analyzed by ¹H-NMR (see FIG. 1). The resulting GPC molecular weights and ethylene glycol end groups are shown in the table below:

| DGO (mol % | EG end | Mn | Mw | PDI |
|---|---|---|---|---|
| w.r.t. FDCA) | (mol %) | (kDa) | (KDa) | (Mw/Mn) |
| 1% | 3.5 | 17.0 | 34.3 | 2.0 |
| 2% | 2.3 | 27.0 | 51.6 | 1.9 |
| 3.5% | <0.1 | 50.7 | 100.9 | 2.0 |

The NMR spectra show that DGO effectively reacts with the ethylene glycol end groups, showing a decrease in the amount of those end groups after each addition. This is also seen from the GPC results, as the molecular weight increases after each addition. [For comparison: for a typical melt polycondensation of PEF without catalyst Mn values of 13 kDa are found. When a catalyst (Sb) is used the Mn increases to 29 kDa. See above “Comparative Example” ]Interestingly, with DGO, and in the absence of catalyst, considerably higher Mn values could be obtained than the typical melt polycondensation with catalyst.

### Conclusion Examples 2 and 2A

The results of these Examples show that using DGO could potentially make SSP obsolete and save time, equipment, energy consumption, and therefore costs. The absence of a catalyst may also lead to a decrease in discoloration of PEF, which is a widely studied area and is often related to the catalytic system.

The resulting polymer of Example 2 was still further processed by SSP, which increased the molecular weight by roughly 50%, 64.6/199.9 kDa (Mn/Mw) and surpassed values typically obtained for PEF. This clearly showed the effectiveness of DGO as molecular weight booster for PEF, especially considering no catalyst was used.

### Example 2B—Effectiveness of DGO and DPO as Molecular Weight Booster (PEF)—in the Absence of a Metal Catalyst

As a first step PEF oligomers were synthesized. A 2 L autoclave was charged with FDCA (624.4 g, 4.0 mol, 1.0 eq.), EG (310.4 g, 5.0 mol, 1.25 eq.) and the ether suppressant TEA hydroxide 35% w/w aqueous solution (0.43 mL, 200 ppm). The oil temperature was set to 220-230° C. with a N₂ flow of 2 L/h. The set temperature was reached in about 15 minutes (internal ˜215° C.). As soon as the internal temperature reached 175° C., stir speed was set to 125 RPM (anchor stirrer). After 3 hours of transesterification the N₂ flow was halted. At this stage 92.7 g of condensate was collected. Next, vacuum was applied and the oil temperature was set to 260-265° C. Full vacuum (<1 mbar) was reached in about 30 minutes and maintained for 1 hour. The colorless to slightly yellowish PEF oligomers were collected on a plate covered with Teflon sheets (707.7 g, 82% yield).

The PEF oligomers (20.0 g, 105.7 mmol, 1.0 eq.) were reacted with either DPO or DGO boosters (6.3 mmol, 6.0 mol % relative to FDCA) at an oil temperature of 260° C. and a N₂ flow of 50 mL/min. First the mixture was melted for 2 minutes and after the mixture was stirred for 5 minutes at 100 RPM. Next, vacuum was applied going from 400 to <1 mbar in 15 minutes. Samples were taken for GPC every 10, 30 and 60 minutes. After 1 hour at full vacuum, the polymer was taken out of the flask in about 10 minutes under a continuous flow of N₂. The exact weight (g) and n (mmol) of each booster and the total polymer weight (g) and yield (%) of each 2^{nd} stage booster reaction can be found in the table below.

| | EG end | | | |
|---|---|---|---|---|
| Booster | (mol %) | Mn (kDa) | Mw (KDa) | PDI (Mw/Mn) |
| DGO | 2.1 | 27.4 | 55.1 | 2.0 |
| DPO | 2.3 | 27.3 | 54.9 | 2.0 |

### Example 3

### PEIT Polymerization from BHET in the Absence of Metal Catalyst

BHET was analyzed for the presence of metals using inductively coupled plasma with optical emission spectroscopy (ICP-OES) as detection technique, using standard protocols. None of the metals (Ge, Zn, Pb, Co, Fe, Ti and Sb) were found to be present above the detection limit of 1 ppm.

503.7 g BHET (1.98 mol; 1 eq), 82.1 g isosorbide (0.56 mol; 0.284 eq) and 33.2 g TPA (0.199 mol; 0.1 eq) were charged to a steel 2 L kiloclave (Buchi). The oil temperature was set to 250° C. with a N₂ bleed of 2 L/h. The set temperature was reached in about 20 minutes (internal ˜230° C.). As soon as the internal temperature reached 200° C., stir speed was set to 100 RPM (anchor stirrer). After 3 hours of transesterification the nitrogen flow was halted, vacuum was applied and the oil temperature was set to 270° C. (250° C. internal). In about 1 hour full vacuum was reached (<1 mbar), and maintained for 2 hours. The torque after polycondensation increased from 500 Ncm to 570 Ncm. Around 130 g of condensate was collected at this stage.

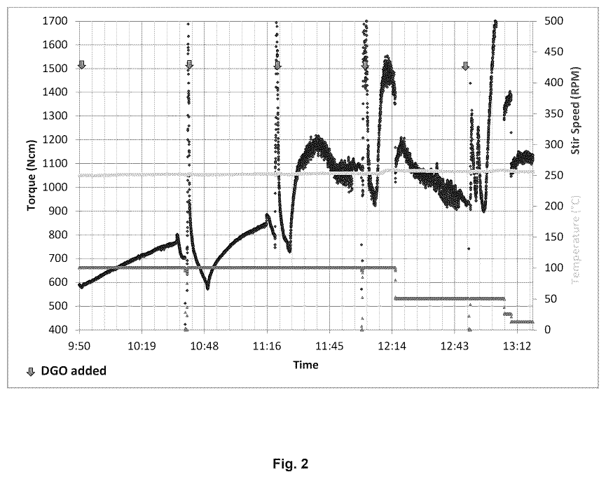

The next day, 12.4 g (2.0 mole % relative to BHET+PTA) of DGO was added to the cooled down post-polycondensate. Subsequently, the oil temperature was set to 270° C., with a N₂ bleed of 2 L/h. As soon as the internal temperature reached 200° C., stir speed was set to 100 RPM. After around 15 minutes nitrogen flow was halted, and vacuum was slowly applied. In about 30 minutes the torque steadily increased to ˜750 Ncm. Then four additional portions of DGO were added: 8, 8, 5 and 6.2 gram (thus, in total DGO added: 39.6 g, 6 mole % relative to BHET+PTA). After each addition the reaction was stirred 5 minutes under a nitrogen flow, after which vacuum was applied for 30 minutes before the next addition. The final torque reached was 1100 Ncm at 12 RPM (255° C.). See FIG. 2. The polymer was extruded in about 1.5 hours by using 3 bars N₂ pressure. The extruded polymer was guided through a water bath and was chipped. The final yield was 350 g (70%) of golden brown polymer chips. The polymer had a high molecular weight of 24.8/55.1 kDa (Mn/Mw) and an isosorbide content of 16.1 mol %. The Tg was 93° C.

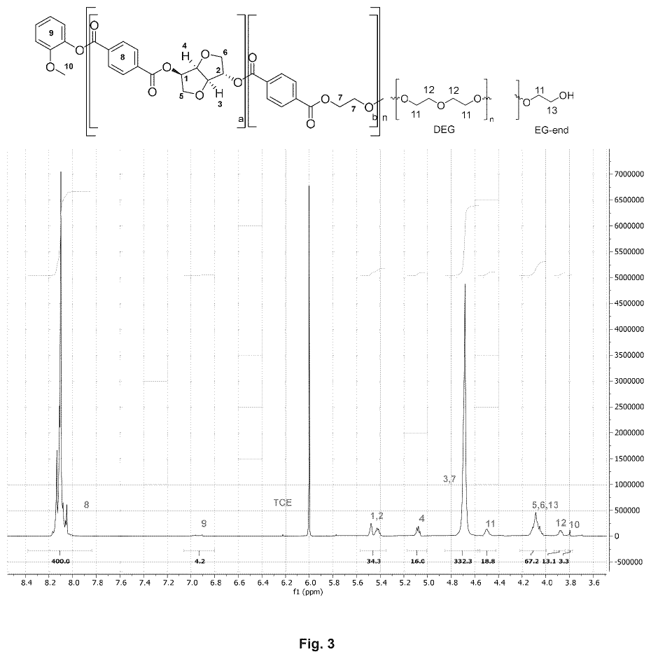

For ¹H NMR, see FIG. 3.

A typical PEIT prior art polymerization with ˜20% isosorbide and a good antimony catalytic system resulted in a molecular weight of 8-9/24-29 kDa (Mn/Mw) [Bersot, J. C, et al., Macromol. Chem. Phys., 2011, 212, 19, 2114-2120]. In the experiments of the present disclosure with DGO as molecular weight booster those molecular weights are easily surpassed without the need to use a catalyst.

### Example 4

PEIF Polymerization from FDCA in the Absence of Catalyst

### (DGO 5 Mol % Relative to FDCA)

702.0 g of FDCA (4.50 mol; 1 eq), 191.0 g of isosorbide (1.31 mol; 0.290 eq), 265.8 g of ethylene glycol (4.28 mol; 0.95 eq) and 0.5 mL of TEAOH (35% aqueous solution) were charged to a steel 2 L kiloclave (Buchi)). The oil temperature was set to 230° C. under a N₂ flow of 2 L/h. The set temperature was reached in about 15 minutes (internal ˜215° C.). As soon as the internal temperature reached 175° C., stir speed was set to 125 RPM (anchor stirrer). After 3.5 hours of transesterification the nitrogen flow was halted. At this stage 188 g of condensate was collected. Vacuum was applied next, and the oil temperature was set to 260-275° C. (243-255° C. internal). In about 30 minutes full vacuum was reached (<1 mbar), and maintained for 2 hours. The torque after polycondensation increased from 500 Ncm to 550 Ncm.

The next day, 40 g (3 mol % relative to FDCA) of DGO was added to the cooled down post-polycondensate. The oil temperature was set to 275° C., under a N₂ flow of 4 L/h. As soon as the internal temperature reached 200° C., stir speed was set to 100 RPM. After around 15 minutes nitrogen flow was halted, and vacuum was slowly applied. Subsequently, another three portions of DGO were added: 15, 10 and 6 gram (thus, in total DGO added: 71 g, 5.2 mol % relative to FDCA). After each addition the reaction was stirred 5 minutes under a nitrogen flow, after which vacuum was applied for 30 minutes before the next addition. The final torque reached was 1020 Ncm at 12 RPM. The polymer was extruded in about 1.5 hours by using 3 bars of N₂ pressure. The extruded polymer was guided through a water bath and was chipped. The final yield was 650 g (78%) of dark polymer chips with a molecular weight of 28.0/66.9 kDa (Mn/Mw). The isosorbide content was 26.2 mol % resulting in a high Tg of 109.9° C.

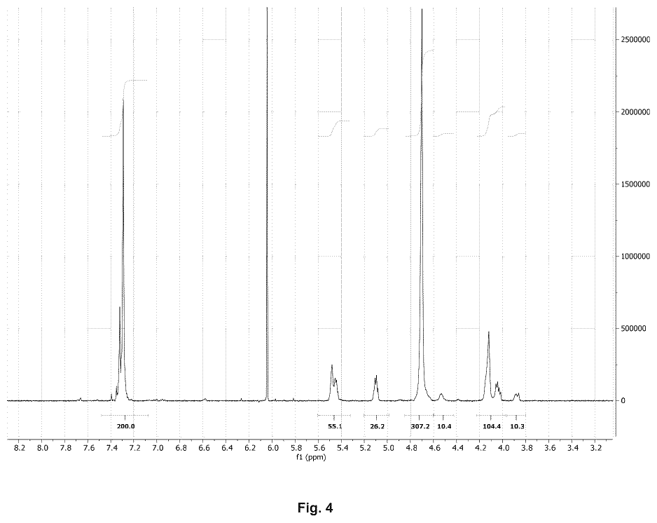

For ¹H NMR, see FIG. 4.

### Example 5

PEIF Polymerization from FDCA in the Absence of Catalyst

### (DGO 9 Mol % Relative to FDCA)

A 100 mL three neck round bottom flask was charged with 19.757 g FDCA flakes (127 mmol, 1 eq), 7.414 g ethylene glycol (119 mmol, 0.94 eq), 6.884 g isosorbide (47 mmol, 0.372 eq) and 17.8 mg of ether suppressant (TEAOH 35% water solution). The round bottom flask was put in an oil bath and was equipped with a mechanical stirrer, nitrogen inlet and short path connected Schlenk flask, all suited for high vacuum. The polymerization was carried out in three steps, transesterification, polycondensation and chain extension.

In the transesterification step, nitrogen flow was set to 50 mL/min, stir speed 100 RPM and the temperature of the oil bath was set to 220° C. The transesterification step had a total duration of 12 hours.

In the polycondensation step, temperature was set to 260° C. and vacuum was applied (200 mbar). Vacuum was slowly decreased to <1 mbar in 30 minutes. Full vacuum was maintained for 1 hour before starting with the molecular weight boosting step.

In the molecular weight boosting step, a total of 3.4 g DGO (9 mol % relative to FDCA) was added to the melt in 5 portions at 275° C. After each addition the melt was stirred for 5 minutes after which vacuum was slowly applied. In 15 minutes full vacuum (1 mbar) was reached and maintained for 10 minutes. The additions were performed under a nitrogen atmosphere.

It was found, that even while using the less reactive isosorbide, high molecular weights were obtained in the absence of catalyst, nor using SSP: 25.1/63.9 kDa (Mn/Mw).

An Overview of the Produced Polymers in Examples 2-5 with the Molecular Weight Booster is Shown in Table 2 Below.

Molecular composition, molecular weight and thermal properties of the
polyesters made with the use of DGO as molecular weight booster. The
molecular weights are determined by GPC (PMMA standards). For comparison,
the percentages of isosorbide (ISO) in some of the feeds are listed.
The reported mole % and moles are based on FDCA or TPA.

| | NMR | Feed | NMR | GPC | GPC | GPC | DSC | Feed | Feed |
|---|---|---|---|---|---|---|---|---|---|
| | DEG | ISO | ISO | Mn | Mw | PDI | Tg | DGO | Scale |
| Analysis method -> | (%) | (%) | (%) | (kDa) | (kDa) | (Mw/Mn) | (° C.) | (mol %) | (mol) |
| Typical PEF with | 2.0 | — | — | 28.6 | 63.0 | 2.2 | | — | 0.19 |
| catalyst Sb | | | | | | | | | |
| (Comparative Ex.) | | | | | | | | | |
| After SSP: | | | | 59.2 | 137.7 | 2.3 | — | — | — |
| PEF (Example 2A) | 4.1 | — | — | 50.7 | 100.9 | 2.0 | 85.2 | 3.5% | 0.13 |
| PEF (Example 2) | 2.4 | — | — | 42.2 | 127.3 | 3.0 | — | 5.1% | 0.13 |
| After SSP: | | | | 64.6 | 199.9 | 3.1 | — | — | — |
| PEIF (Example 5) | 2.3 | — | 29.9 | 25.1 | 63.9 | 2.6 | 114.5 | 8.9% | 0.13 |
| PEIF (Example 4) | 2.6 | 29.1 | 26.2 | 28.0 | 66.9 | 2.4 | 109.9 | 5.2% | 4.50 |
| PEIT (Example 3) | 3.3 | 25.8 | 16.1 | 24.8 | 55.1 | 2.2 | 93.0 | 6.0% | 2.17 |

### Example 6

Small Scale Polymerization of PET with DGO Molecular Weight Boosting in the Absence of a Metal Catalyst

A 100 mL three neck round bottom flask was charged with 21.929 g terephthalic acid (132 mmol, 1 eq.), 20.482 g ethylene glycol (330 mmol, 2.5 eq.) and 15 mg of tetraethylammonium hydroxide (as a 35% aqueous solution; 0.1 mmol, 0.0008 eq.). The round bottom flask was put in an oil bath and equipped with a mechanical stirrer, nitrogen inlet and short path connected Schlenk flask, all suited for high vacuum. The polymerization was carried out in three steps, esterification, polycondensation and molecular weight boosting step.

In the esterification step, the nitrogen flow was set to 50 mL/min, stir speed to 150 rpm and the temperature of the oil bath was set to 225° C. The set temperature was reached in about 40 minutes. The first esterification step was considered complete after a clear melt was obtained after around 15 hours. The esterification was continued for an additional hour before heating was stopped and the reactor was left to cool to room temperature. On the next day, the oil bath temperature was set to 270° C. Once reached, a vacuum was applied to the reactor (400 mbar) and the pressure was slowly decreased to <1 mbar within one hour. The polymer melt was stirred at 100 rpm for 2 h at <1 mbar. No significant change in melt viscosity was observed, which indicates no polymer chain growth. Next, the reactor was purged with nitrogen and a sample (6i) was taken from the reaction melt. 0.8 g DGO (2.6 mmol, 2 mol % respective terephthalic acid) were added to the melt and the reaction mixture was stirred at 100 rpm for 5 minutes under a nitrogen atmosphere. Then a vacuum of <1 mbar was applied to the reactor and the reaction was stirred for 30 minutes before the reactor was purged with nitrogen. A reaction melt sample (6ii) was taken before another 0.8 g of DGO (2.6 mmol, 2 mol % respective terephthalic acid) were added to the reaction and stirred at 30 rpm for 5 minutes under a nitrogen atmosphere. Due to a significant increase in melt viscosity, the oil bath temperature was set to 300° C. A vacuum of <1 mbar was applied to the reactor and the reaction was stirred for another 30 minutes before the reactor was purged with nitrogen. A last melt sample (6iii) was taken before 0.4 g of DGO (1.3 mmol, 1 mol % respective terephthalic acid) were added to the reaction mixture. After stirring for 5 minutes under a nitrogen atmosphere, a vacuum of <1 mbar was applied and held for approximately 10 minutes. The reactor was purged with nitrogen and the reaction product (6-Product) was removed from the reactor.

| Sample | Mn (kDa) | Mw (kDa) | PDI (Mw/Mn) | T_{g} (° C.) |
|---|---|---|---|---|
| 6i | 4.1 | 8.4 | 2.1 | — |
| 6ii | 6.3 | 12.9 | 2.0 | — |
| 6iii | 11.0 | 22.8 | 2.1 | — |
| 6-Product | 17.1 | 35.9 | 2.1 | 74 |

### Example 7

Small Scale Polymerization of PET with DGO Molecular Weight Boosting in the Presence of a Metal Catalyst

A 100 mL three neck round bottom flask was charged with 33.559 g bis(2-hydroxyethyl) terephthalate (132 mmol, 1 eq.) and 0.022 g titanium(IV) butoxide (0.07 mmol, 0.05 eq.). The round bottom flask was put in an oil bath and equipped with a mechanical stirrer, nitrogen inlet and short path connected Schlenk flask, all suited for high vacuum. The polymerization was carried out in three steps, transesterification, polycondensation and molecular weight boosting step.

In the transesterification step, nitrogen flow was set to 50 mL/min, stir speed to 100 RPM and the temperature of the oil bath was set to 250° C. The set temperature was reached in about 40 minutes and transesterification was conducted for 2 h. The oil bath temperature was set to 270° C. and vacuum was applied to the reactor (400 mbar). The pressure was slowly decreased to <1 mbar within one hour. The melt was stirred at <1 mbar for 20 minutes, after which the stirring speed was decreased to 30 rpm and the oil bath temperature was increased to 300° C. After 20 minutes the oil bath temperature reached 300° C. and the reactor was purged with nitrogen. A melt sample (7i) was taken from the reaction mixture and 0.2 g DGO (0.66 mmol, 0.5 mol % relative to BHET) were added. The reaction mixture was stirred for 5 minutes under a nitrogen atmosphere. Then a vacuum of <1 mbar was applied and the reaction mixture was stirred for 20 minutes. The reactor was purged with nitrogen and the polymer (7-Product) was removed from the reactor.

| Sample | Mn (kDa) | Mw (kDa) | PDI (Mw/Mn) | T_{g} (° C.) |
|---|---|---|---|---|
| 7i | 20.4 | 42.1 | 2.1 | — |
| 7-Product | 40.8 | 102.2 | 2.5 | 76 |

### Example 8

### Small Scale Reactivity Comparison Between DPO and DGO for PEIF Synthesis (No Metal Catalyst)

First a batch of PEIF oligomers was produced. FDCA (200.0 g, 1.3 mol, 1.0 eq.), ISO (60.3 g, 0.41 mol, 0.32 eq.), EG (73.0 g, 1.2 mol, 0.92 eq.) and TEA hydroxide 35% w/w aq. soln. (150 mg, 200 ppm) were charged to a 500 mL 3-neck flask equipped with an overhead stirrer, condenser, N₂ (50 mL/min) inlet and thermometer. The oil temperature was set to 230° C., which was reached in about 15 min. As soon as the oil temperature reached 190° C., stir speed was set to 125 RPM. After 3.5 h of transesterification a clear melt was obtained and the N₂ flow was halted. At this stage 38.1 g of condensate was collected. Next, vacuum was applied and the oil temperature was set to 260° C. Full vacuum (<1 mbar) was reached in about 30 min, and maintained for 2 h. The torque after polycondensation increased from 3.8 to 4.4 Ncm. The colorless to slightly yellowish PEIF oligomers were collected on a plate covered with Teflon sheets (227 g, 1.1 mol, 97% yield).

These PEIF oligomers were reacted with either DPO or DGO booster: a 100 mL three neck round bottom flask was charged with 10 g PEIF oligomers and 7 mol % of booster relative to FDCA (DPO: 0.846 g or DGO: 1.036 g). The round bottom flask was put in an oil bath and equipped with a mechanical stirrer, nitrogen inlet and short path connected Schlenk flask, all suited for high vacuum. Nitrogen flow was set to 50 mL/min and the temperature of the oil bath was set to 260° C. As soon as a melt was obtained, the stir speed was set to 75 RPM. The set temperature was reached in about 25 minutes. At the set temperature, vacuum (1 mbar) was applied and maintained for 1 hour, after which the polymer was collected (under a nitrogen atmosphere) and taken for analysis. ¹H-NMR analysis showed that the isosorbide content was 25% (based on total diol and relative to FDCA signal integral).

The resulting polymer was further boosted by the same procedure: 4 g of the polymer mixture was taken, which was reacted with an additional 2 mol % of booster (DPO: 0.0957 g or DGO: 0.1219 g) for 40 min at 260° C. (1 mbar), after which the vacuum was replaced by a nitrogen atmosphere and under a nitrogen flow (50 mL/min) samples were taken for analysis. This was followed by a final addition of 1 mol % booster (DPO: 0.0497 g or DGO: 0.0637 g) to the melt. After addition, the melt was stirred for 5 minutes after which vacuum was applied. The polymerization was continued for 45 min at 260° C. (1 mbar), after which the polymer was collected and taken for analysis. The results are shown in the table below. The DGO booster showed significantly higher molecular weights as the reaction progressed with the addition of booster compared to DPO.

| | DPO | | | DGO | | |
|---|---|---|---|---|---|---|
| Cumulative booster loading | Mn | Mw | | Mn | Mw | |
| (mol %) | (kDa) | (kDa) | PDI | (kDa) | (kDa) | PDI |
| 7 | 5.9 | 13.2 | 2.25 | 5.8 | 13.4 | 2.29 |
| 9 | 7.7 | 17.4 | 2.25 | 8.4 | 19.1 | 2.26 |
| 10 | 8.9 | 20.6 | 2.32 | 12.9 | 32.0 | 2.47 |

### NMR Analysis

In the ¹H-NMR of the PEIT polyester of Example 3 (FIG. 3), all signals could be assigned to the molecular structure of PEIT, which corresponds well to the literature reported spectra. Only additional signals of the guaiacyl end groups are observed. This likely indicates that there was a little excess of DGO added.

No signals indicative of oxalate in the polymer chain were observed. If present, ethylene glycol oxalate ester signals would be observable in the spectrum a bit lower than the terephthalate ester signals, 4.64-4.57 ppm.

Besides this, the presence of oxalate in the polymer chain would lower the TPA to diol ratio. However, after normalizing the diol integrals (EG, DEG, ISO) and TPA integral, a ratio of 1 is obtained between them.

Also, there were no signs of the ethylene oxalate ring, which would result in a sharp singlet at 4.62 ppm.

The same was found for the resulting ¹H-NMR of the PEIF polyester of Example 4 (FIG. 4), similar to PEIT all signals could be assigned and no signals indicative of the presence of an oxalate unit could be observed. This indicates that under the used conditions oxalate readily leaves the polymer after chain extension.

3D Printing with Catalyst Free PEIT and PEIF

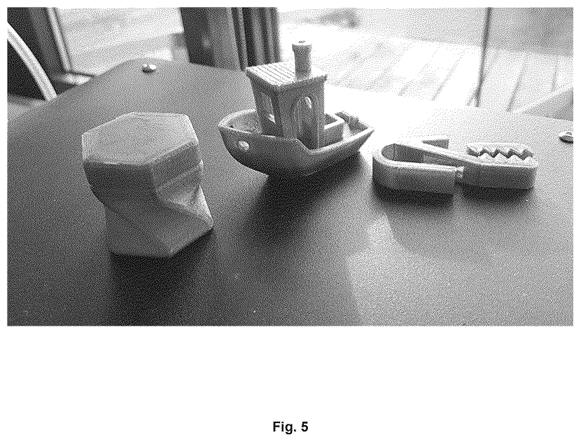

It was found that PEIT with an Mw above 50 kDa shows good ductility and can for example be used to 3D print. The 350 g of PEIT and 650 g of PEIF polymers produced in Examples 3 and 4, respectively, were further processed in a filament for 3D printing. This was done by using a filament maker (3Devo precision filament). Both PEIT and PEIF were successfully processed in a couple of hundred grams of filament with a diameter of 2.85 mm. After processing PEIF in the filament maker, however, the molecular weight dropped to 65% of its original value 18.4/44.0 kDa (Mn/Mw). Unfortunately, this made the filament too brittle to print with. The PEIT filament, on the other hand, was strong and printable. This way several 3D printing designs were produced. The filament was used on a Ultimaker extended 3D printer to produce several designs from Thingiverse (a website dedicated to the sharing of user-created digital design file). First a well-known benchy was printed, which came out really neat, apart from some stringing. Second, a print in place mechanical clamp was printed and worked directly after taken it from the build plate. Next, a small storage box with twisting lid was printed. See FIG. 5. Overall these prints show that the polymer, filament and print settings were all in good order.

Introducing isosorbide into PET or PEF could be interesting for 3D printing as the Tg increases while the required printing temperature is reduced. Also, the material becomes amorphous with isosorbide contents above 15%, improving printability and aesthetics. For PEIT with 16% of isosorbide the required printing temperature was 230° C. with a Tg of 93° C. This is similar to what is typically used for PETG while the Tg is higher. These high temperatures would allow the use of the isosorbide containing polymers in more thermal demanding applications. It would be possible to wash the prints in the dishwasher, or hold hot liquids. PEIF and PEIT, being polyesters, are good recyclable materials, of which PEIF can be made fully biobased. As far as we know, currently there are no biobased polymers available for 3D printing with this combination of good thermal and mechanical properties.

1. A process for the production of a (high molecular weight) polyester (co)polymer, comprising
(a) adding a diphenyl oxalate ester to a starting polyester (co)polymer at least comprising alcohol end groups and units derived from 1,2-diols,
wherein the phenyl group in the diphenyl oxalate ester is optionally substituted, the substituent being selected from one or more of o-, m- and p-C1-C6 alkoxy, or o-, m- and p-C1-C6 alkyl;
(b) in case a temperature is not already higher than 220° C., elevating the temperature of the mixture resulting from step (a) to at least 220° C., and reducing the pressure, for a period of time sufficient to obtain a polyester (co)polymer product wherein an amount of oxalate units that remain in the (co)polymer is less than added in the form of the diphenyl oxalate ester; and no or less than 1 mole % oxalate units are present, the percentage relative to a total amount of monomer units, the product having a higher molecular weight than that of the starting polyester (co)polymer;
wherein the process is carried out in the absence of a metal catalyst.

2. The process of claim 1, comprising adding an amount of 0.2 to 10 mole % of the diphenyl oxalate ester to the starting polyester (co)polymer, the percentages being relative to the total amount of monomers in the starting polyester (co)polymer.

3. The process of claim 1, wherein the diphenyl oxalate ester is diphenyl oxalate or bis(2-methoxyphenyl) oxalate.

4. The process of claim 1, wherein at least one of the units derived from a 1,2-diol is derived from an aliphatic diol selected from mono ethylene glycol, 1,2 propanediol, 1,2-butanediol, 2,3-butanediol or 1,2-cyclohexanediol.

5. The process of claim 4, wherein the starting polyester (co)polymer comprises additional diol derived monomer units, preferably selected from cis- and/or trans-2,2,4,4-tetramethyl-1,3-cyclobutanediol, or 1,4:3,6-dianhydrohexitols.

6. The process of claim 1, wherein the starting polyester (co)polymer comprises dicarboxylic acid derived units, the dicarboxylic acids or any esters thereof selected from (hetero)aromatic dicarboxylic acids or any esters thereof and C2-C18 aliphatic dicarboxylic acids or any esters thereof, which are linear, cyclic or branched.

7. The process of claim 1, comprising (i) providing or producing the starting polyester (co)polymer, wherein the process for producing the polyester (co)polymer comprises esterification/transesterification and polycondensation;
(ii) adding the diphenyl oxalate ester to the starting polyester (co)polymer;
(iii) elevating the temperature of the mixture resulting from step (ii) to at least 220° C., or, in case the temperature is already higher than 220° C., maintaining the temperature for a period of time;
(iv) reducing pressure, preferably to at most 5 mbar, more preferably to equal to or below 1 mbar, thereby producing a (co)polymer product; and
(v) optionally repeating steps (ii) to (iv) one or more times with as starting material the (co)polymer with the higher molecular weight of the previous step (iv) until a final polyester (co)polymer product is produced wherein no or less than 1 mole % oxalate units are present, the percentage relative to the total amount of monomer units, and with the desired high molecular weight properties.

8. The process of claim 7, wherein step (i) comprises producing the starting polyester (co)polymer by reacting dicarboxylic acids or esters thereof with diols and/or polyols and/or oligomers with diol derived end groups, in the presence of a catalyst, wherein at least one of the diols and/or polyols and/or oligomers with diol derived end groups comprises a vicinal diol group.

9. The process of claim 7, wherein the polyester (co)polymer is a recycled polyester material or derived from a recycled polyester material.

10. A polyester (co)polymer obtainable by, or obtained by, claim 1, being a metal catalyst free polyester (co)polymer, selected from:
poly(ethylene furan-2,5-dicarboxylate);
poly(ethylene co-isosorbide furan-2,5-dicarboxylate);
poly(ethylene co-isosorbide co-cyclohexanedimethylene furan-2,5-dicarboxylate);
poly(ethylene co-isosorbide terephthalate) with isosorbide content of 15% or higher;
poly(ethylene co-isosorbide co-cyclohexanedimethylene terephthalate);
poly(ethylene furan-2,5-dicarboxylate co-terephthalate); or
poly(ethylene co-isosorbide furan-2,5-dicarboxylate co-terephthalate).

11. A composition comprising the polyester (co)polymer of claim 10, and in addition one or more additives and/or one or more additional other (co)polymers.

12. An article comprising the composition comprising a polyester (co)polymer according to claim 11 and one or more additives and/or additional polymers.
